(19) United States
(12) Patent Application Publication
(10) Pub. No.: US 2025/0157734 A1
(43) Pub. Date: May 15, 2025

(54) MULTILAYER CERAMIC CAPACITOR AND METHOD OF FABRICATING THE SAME

(71) Applicant: SAMSUNG ELECTRO-MECHANICS CO., LTD., Suwon-si (KR)

(72) Inventors: Taeyoon Kim, Suwon-si (KR); Huieun Kim, Suwon-si (KR); Hyungjoon Jeon, Suwon-si (KR); Byung Hyun Park, Suwon-si (KR); Jeong Ryeol Kim, Suwon-si (KR)

(73) Assignee: SAMSUNG ELECTRO-MECHANICS CO., LTD., Suwon-si (KR)

(21) Appl. No.: 18/630,858

(22) Filed: Apr. 9, 2024

(30) Foreign Application Priority Data
Nov. 13, 2023 (KR) 10-2023-0156206

(51) Int. Cl. H01G 4/12; H01G 4/30

(52) U.S. Cl. CPC H01G 4/1281; H01G 4/1227; H01G 4/30

(57) ABSTRACT

Provided are a multilayer ceramic capacitor and a method of fabricating the same. The multilayer ceramic capacitor comprises a capacitor body including dielectric layers and internal electrode layers; and an external electrode disposed outside the capacitor body, wherein the dielectric layer includes a plurality of dielectric grains and grain boundaries located between the adjacent dielectric grains, the grain boundary includes a barium titanate-based primary component containing barium (Ba) and titanium (Ti), and inorganic element including silicon (Si), and a standard deviation of atom % of the inorganic element to the total amount of components of the grain boundary is 0.20 to 0.80, and the standard deviation is obtained as the square root of the average of the squares of the deviations.

### CROSS-REFERENCE TO RELATED APPLICATION

This application claims priority to and the benefit of Korean Patent Application No. 10-2023-0156206 filed in the Korean Intellectual Property Office on Nov. 13, 2023, the entire contents of which are incorporated herein by reference.

### BACKGROUND

The present disclosure relates to a multilayer ceramic capacitor and a method of fabricating the same.

Electronic components using ceramic materials include capacitors, inductors, piezoelectric elements, varistors, thermistors, or the like. Among these ceramic electronic components, a multilayer ceramic capacitor (MLCC) may be used in various electronic devices due to advantages of being small, securing high capacity, and being easy to mount.

For example, the MLCC may be used in a chip-type condenser that is mounted on substrates of various electronic products such as imaging devices such as a liquid crystal display (LCD), a plasma display panel (PDP), and an organic light-emitting diode (OLED), computers, personal portable terminals and smartphones and serves to charge or discharge electricity.

Recently, as the MLCC becomes more highly integrated, the MLCC is becoming ultra-small, and high reliability under thin-layer design is required.

### SUMMARY

The present disclosure attempts to provide a multilayer ceramic capacitor having high reliability.

The present disclosure also attempts to provide a method of fabricating the multilayer ceramic capacitor.

Some embodiments of the present disclosure provide a multilayer ceramic capacitor including a capacitor body including dielectric layers and internal electrode layers; and an external electrode disposed outside the capacitor body, wherein the dielectric layer includes a plurality of dielectric grains and grain boundaries located between the adjacent dielectric grains, the grain boundary includes a barium titanate-based primary component containing barium (Ba) and titanium (Ti), and inorganic elements including silicon (Si), and a standard deviation of atom % of the inorganic elements to the total amount of components of the grain boundary is 0.20 to 0.80, and the standard deviation is obtained as the square root of the average of the squares of the deviations. The grain boundary may have a barium (Ba)-inorganic element composite phase.

The grain boundary may further include nickel (Ni), and in the grain boundary, an atomic ratio of the inorganic elements to nickel (Ni) may be 1.00 to 2.10.

In the grain boundary, an atomic ratio of the inorganic elements to titanium (Ti) may be 0.010 to 0.065.

The inorganic element may further include at least one selected from the group consisting of dysprosium (Dy), magnesium (Mg), manganese (Mn), barium (Ba), aluminum (Al), vanadium (V), calcium (Ca), lithium (Li), copper (Cu), terbium (Tb), niobium (Nb), samarium (Sm), gadolinium (Gd), and combinations thereof.

The grain boundary may further include a secondary component selected from the group consisting of dysprosium (Dy), terbium (Tb), manganese (Mn), vanadium (V), barium (Ba), silicon (Si), aluminum (Al), calcium (Ca), and combinations thereof.

The secondary component may include dysprosium (Dy), and in the grain boundary, an atomic ratio of the inorganic elements to the secondary component of dysprosium (Dy) may be 0.10 to 3.00.

At least one of the plurality of dielectric grains may include a core-shell structure including a core portion and a shell portion surrounding the core portion.

The shell portion may include a barium titanate-based primary component containing barium (Ba) and titanium (Ti), and an inorganic element including silicon (Si).

The inorganic element of the shell portion may further include at least one selected from the group consisting of dysprosium (Dy), magnesium (Mg), manganese (Mn), barium (Ba), aluminum (Al), vanadium (V), calcium (Ca), lithium (Li), copper (Cu), terbium (Tb), niobium (Nb), samarium (Sm), gadolinium (Gd), and combinations thereof.

The shell portion may further include a secondary component comprising at least one selected from the group consisting of dysprosium (Dy), terbium (Tb), manganese (Mn), vanadium (V), barium (Ba), silicon (Si), aluminum (Al), calcium (Ca), or combinations thereof.

The capacitor body may have an active area in which the dielectric layers and the internal electrode layers are alternately disposed, and during Scanning Electron Microscope-Energy Dispersive Spectroscopy (SEM-EDS) line analysis for the active area, the amplitude of the peak of silicon (Si) in the dielectric layer may be 8.6 kcps to 25 kcps.

Another embodiments of the present disclosure provide a method of fabricating a multilayer ceramic capacitor including: preparing dielectric powder in which the surface of a barium titanate-based primary component containing barium (Ba) and titanium (Ti) is coated with inorganic elements including silicon (Si); preparing a dielectric green sheet using a dielectric slurry including the dielectric powder and forming a conductive paste layer on the surface of the dielectric green sheet; preparing a dielectric green sheet laminate by laminating the dielectric green sheets on which the conductive paste layer is formed; preparing a capacitor body including dielectric layers and internal electrode layers by firing the dielectric green sheet laminate; and forming an external electrode on one surface of the capacitor body, in which the dielectric layer includes a plurality of dielectric grains and grain boundaries located between the adjacent dielectric grains, the grain boundary includes a barium titanate-based primary component containing barium (Ba) and titanium (Ti), and inorganic elements including silicon (Si), and a standard deviation of atom % of the inorganic elements to the total amount of components of the grain boundary is 0.20 to 0.80, and the standard deviation is obtained as the square root of the average of the squares of the deviations.

The preparation of the dielectric powder may include performing hydrothermal synthesis and grain growth of the barium titanate-based primary component powder; adding an inorganic salt containing silicon (Si) after the grain growth is completed; and performing heat treatment after adding the inorganic salt.

The inorganic salt may further include at least one selected from the group consisting of dysprosium (Dy), magnesium (Mg), manganese (Mn), barium (Ba), aluminum (Al), vanadium (V), calcium (Ca), lithium (Li), copper (Cu), terbium (Tb), niobium (Nb), samarium (Sm), gadolinium (Gd), and combinations thereof.

The inorganic salt may include an alkoxide-based compound.

The inorganic salt may be added in an amount of 0.1 parts by mole to 5.0 parts by mole based on 100 parts by mole of the barium titanate-based primary component powder.

The heat treatment may be performed at a temperature of 100° C. to 300° C.

The dielectric slurry may further include secondary component powder including at least one selected from the group consisting of a dysprosium (Dy)-containing compound, a terbium (Tb)-containing compound, a manganese (Mn)-containing compound, a vanadium (V)-containing compound, a barium (Ba)-containing compound, a silicon (Si)-containing compound, an aluminum (Al)-containing compound, a calcium (Ca)-containing compound, and combinations thereof.

The secondary component powder may be included in an amount of 0.01 parts by mole to 5 parts by mole based on 100 parts by mole of the barium titanate-based primary component powder.

According to an embodiment, since the multilayer ceramic capacitor has a dielectric layer in which additive components are uniformly distributed, it is possible to secure high reliability even in a thin dielectric layer.

### BRIEF DESCRIPTION OF THE DRAWINGS

FIG. 1 is a perspective view illustrating a multilayer ceramic capacitor according to an embodiment.

FIG. 2 is a cross-sectional view of the multilayer ceramic capacitor of FIG. 1 taken along line I-I′.

FIG. 3 is a cross-sectional view of the multilayer ceramic capacitor of FIG. 1 taken along line II-II′.

FIG. 4 is a schematic diagram illustrating a structure of a dielectric layer according to an embodiment.

FIG. 5 is a schematic diagram illustrating a method of preparing dielectric powder according to an embodiment.

FIG. 6 is a schematic diagram illustrating a method of preparing a dielectric layer according to an embodiment.

FIG. 7 is a TEM analysis image of an active area of a multilayer ceramic capacitor according to Example 1.

FIG. 8 is a SEM-EDS line analysis image of a cover portion and an active area of the multilayer ceramic capacitor according to Example 1.

FIG. 9 is a SEM-EDS line analysis image of a cover portion and an active area of a multilayer ceramic capacitor according to Comparative Example 1.

FIG. 10 is a graph showing high-temperature stress reliability of the multilayer ceramic capacitor according to Example 1.

FIG. 11 is a graph showing high-temperature stress reliability of the multilayer ceramic capacitor according to Comparative Example 1.

### DETAILED DESCRIPTION OF THE EMBODIMENTS

In the following detailed description, only certain embodiments of the present disclosure have been shown and described, simply by way of illustration. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

Further, the accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise,” and variations such as “comprises” or “comprising,” will be understood to imply the inclusion of stated elements but not the exclusion of any other elements.

Further, in the entire specification, when it is referred to as “on a plane”, it means when a target part is viewed from above, and when it is referred to as “on a cross-section,” it means when the cross-section obtained by cutting a target part vertically is viewed from the side.

Further, throughout the specification, when it is referred to as “connected”, this does not only mean that two or more constituent elements are directly connected but may mean that two or more constituent elements are indirectly connected through another constituent element, are physically connected, electrically connected, or are integrated even though two or more constituent elements are referred as different names depending on a location and a function.

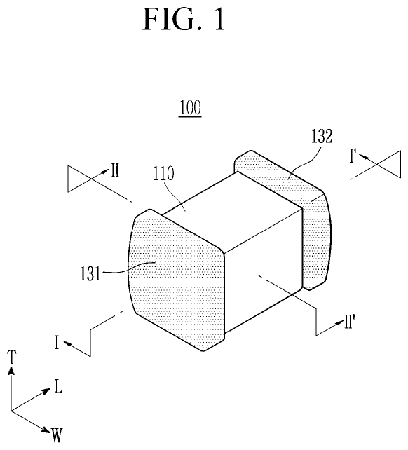

Hereinafter, a multilayer ceramic capacitor according to an embodiment will be described with reference to FIGS. 1 to 3.

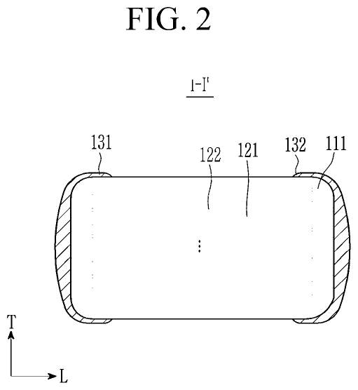

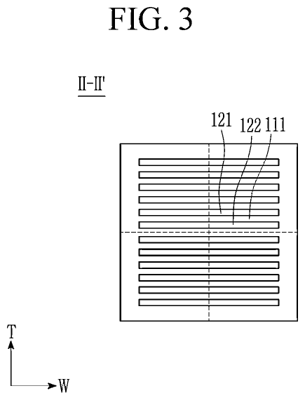

FIG. 1 is a perspective view illustrating a multilayer ceramic capacitor according to an embodiment, FIG. 2 is a cross-sectional view of the multilayer ceramic capacitor of FIG. 1 taken along line I-I′, and FIG. 3 is a cross-sectional view of the multilayer ceramic capacitor of FIG. 1 taken along line II-II′.

A L-axis, a W-axis, and a T-axis illustrated in FIGS. 1 to 3 represent a longitudinal direction, a width direction, and a thickness direction of a capacitor body 110, respectively. Here, the thickness direction (T-axis direction) may be a direction perpendicular to the wide surface (main surface) of sheet-shaped components, and for example, may be used as the same concept as a laminating direction in which dielectric layers 111 are laminated, for example. The longitudinal direction (L-axis direction) may be a direction extending parallel to the wide surface (main surface) of the sheet-shaped components and may be approximately perpendicular to the thickness direction (T-axis direction), and for example, may be a direction in which a first external electrode 131 and a second external electrode 132 are located at both sides. The width direction (W-axis direction) may be a direction extending parallel to the wide surface (main surface) of the sheet-shaped components and may be approximately perpendicular to the thickness direction (T-axis direction) and the longitudinal direction (L-axis direction), and the length in the longitudinal direction (L-axis direction) of the sheet-shaped components may be longer than the length in the width direction (W-axis direction) thereof.

Referring to FIGS. 1 to 3, a multilayer ceramic capacitor 100 according to some embodiments of the present disclosure includes a capacitor body 110 and external electrodes 131 and 132 disposed outside the capacitor body 110. The external electrodes may include a first external electrode 131 and a second external electrode 132 disposed at both ends of the capacitor body 110 facing each other in the longitudinal direction (L-axis direction).

The capacitor body 110 may have, for example, an approximately hexahedral shape.

For convenience of description of an embodiment, both surfaces of the capacitor body 110 facing each other in the thickness direction (T-axis direction) are referred to as a first surface and a second surface, both surfaces that are connected to the first surface and the second surface and face each other in the longitudinal direction (L-axis direction) are referred to as a third surface and a fourth surface, and both surfaces that are connected to the first surface and the second surface and connected to the third surface and the fourth surface, and face each other in the width direction (W-axis direction) are referred to as a fifth surface and a sixth surface.

As an example, the first surface, which is a lower surface, may be a surface facing a mounting direction. In addition, the first to sixth surfaces may be flat, but an embodiment is not limited thereto. For example, the first to sixth surfaces may be curved surfaces with convex central portions, and the edges at the boundaries of each surface may be rounded.

The shape and dimensions of the capacitor body 110 and the laminating number of dielectric layers 111 are not limited to those illustrated in the drawings of the present embodiment.

The capacitor body 110 includes a plurality of dielectric layers 111 and internal electrode layers 121 and 122. Specifically, the capacitor body 110 includes a first internal electrode 121 and a second internal electrode 122 alternately disposed in the thickness direction (T-axis direction) with the plurality of dielectric layers 111 interposed therebetween.

At this time, the boundaries between adjacent dielectric layers 111 of the capacitor body 110 may be integrated so that it is difficult to be identified without using a scanning electron microscope (SEM).

The capacitor body 110 may have an active area. The active area is an area where the dielectric layers 111 and the internal electrode layers 121 and 122 are alternately disposed and is a part that contributes to forming the capacitance of the multilayer ceramic capacitor 100. Specifically, the active area may be an area where the first internal electrodes 121 or the second internal electrodes 122 laminated along the thickness direction (T-axis direction) overlap.

In addition, the capacitor body 110 may further include a cover portion and a side margin portion.

The cover portion is a thickness direction margin portion and may be located on the first and second sides of the active area in the thickness direction (T-axis direction). The cover portion may be formed by a single dielectric layer 111 or laminating two or more dielectric layers 111 on the upper and lower surfaces of the active area.

The side margin portion may be referred to as a side cover portion and may be located on both side ends of the active area facing each other in the width direction (W-axis direction), that is, the fifth and sixth surfaces of the capacitor body 110. The side margin portion may be formed by applying a conductive paste layer only to a partial area of a dielectric green sheet when applying the conductive paste layer for the internal electrode layer on the surface of the dielectric green sheet, laminating dielectric green sheets not applied with the conductive paste layer on both sides of the surface of the dielectric green sheet, and then firing the laminated dielectric green sheets.

The cover portion and the side margin portion both serve to prevent damage to the first internal electrode 121 and the second internal electrode 122 due to physical or chemical stress.

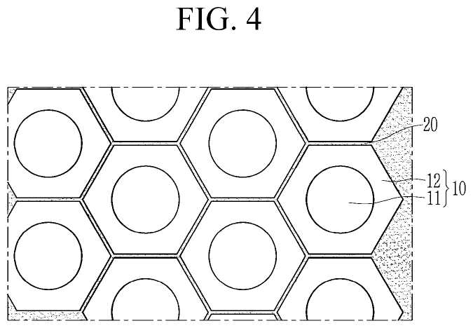

Hereinafter, the dielectric layer 111 will be described with reference to FIG. 4.

FIG. 4 is a schematic diagram illustrating a structure of the dielectric layer according to some embodiments of the present disclosure.

Referring to FIG. 4, the dielectric layer may include a plurality of dielectric grains 10 and grain boundaries 20 located between the adjacent dielectric grains 10.

The grain boundary 20 may include a barium titanate-based primary component containing barium (Ba) and titanium (Ti), and inorganic elements including silicon (Si).

The barium titanate-based primary component may be a dielectric base material, may have a high dielectric constant, and may contribute to forming the dielectric constant of the multilayer ceramic capacitor 100.

The barium titanate-based primary component may include, for example, at least one selected from the group consisting of BaTiO₃, Ba(Ti, Zr)O₃, Ba(Ti, Sn)O₃, (Ba, Ca)TiO₃, (Ba, Ca) (Ti, Ca)O₃, (Ba, Ca) (Ti, Zr)O₃, (Ba, Ca) (Ti, Sn)O₃, (Ba, Sr)TiO₃, (Ba, Sr) (Ti, Zr)O₃, (Ba, Sr) (Ti, Sn)O₃, and combinations thereof.

The inorganic elements may be uniformly distributed in the grain boundary 20. According to some embodiments, dielectric powder with additive components coated on the surface of the barium titanate-based primary component may be prepared by adding the additive components such as inorganic elements in the form of inorganic salts to obtain a multilayer ceramic capacitor in which the inorganic elements are uniformly distributed in the dielectric layer 111, specifically the grain boundary 20.

Specifically, in the grain boundary 20, a standard deviation of atom % of the inorganic elements to the total amount of components of the grain boundary 20 may be 0.20 to 0.80, for example, 0.20 to 0.70. When the standard deviation of the content of the inorganic elements is in the range, the inorganic elements such as silicon (Si) may be uniformly distributed in the grain boundary 20, and accordingly, a thin multilayer ceramic capacitor with excellent reliability may be secured.

A standard deviation (o) of atom % of the inorganic elements may be obtained by squaring and summing the atom % deviations, dividing the sum by the number of measurements, and finding the square root, that is, obtained as the square root of the average of the squares of the atom % deviations as in Equation 1 below.

$$σ = \sqrt{\frac{1}{n} {\sum }_{i = 1}^{n} {( {x}_{i} - \overline{x} )}^{2}} \qquad [ Equation 1 ]$$

The standard deviation of atom % of inorganic elements at the grain boundary 20 may be obtained by transmission electron microscopy-energy dispersive spectroscopy (TEM-EDS) analysis.

Specifically, a cross-sectional sample may be obtained to observe an active area of the capacitor body 110 in which the dielectric layers 111 and the internal electrode layers 121 and 122 cross each other, by putting and curing the multilayer ceramic capacitor 100 in an epoxy mixing solution, and then polishing a W- and T-axis directional surface (WT surface) of the capacitor body 110 to a depth of ½ in the L-axis direction, and fixing the WT surface and then maintaining the WT surface in a vacuum atmosphere chamber. Next, the active area of the cross-sectional sample may be measured under a transmission electron microscope (TEM). The TEM may be performed using a Xe-FIB (focused ion beam) under conditions of an acceleration voltage of 200 kV and an analysis magnification of 79 k times, and the dielectric layers 111 and the internal electrode layers 121 and 122 may be measured to show at least one layer, for example, one layer to ten layers. Next, in the TEM image of the measured cross-sectional sample, EDS analysis is performed on at least one point, for example, 1 to 100, 2 to 50, or 3 to 30 points at the grain boundary in the dielectric layer to obtain the standard deviation of atom % of the inorganic elements.

The grain boundary 20 may have a barium (Ba)-inorganic element composite phase. As the barium (Ba)-inorganic element composite phase is formed in the grain boundary 20, firing at a low temperature is possible, and the reliability of the multilayer ceramic capacitor may be improved by improving grain boundary resistance.

The grain boundary 20 may further include nickel (Ni). Nickel (Ni) is a component used for forming the internal electrode layers 121 and 122 and may be a component derived from dispersion into the dielectric layer 111 after firing.

In the grain boundary 20, an atomic ratio X/Ni of inorganic elements (X) to nickel (Ni) may be 1.00 to 2.10, for example, 1.01 to 1.90. When the atomic ratio X/Ni of inorganic elements to nickel (Ni) is within the range, the reliability of the multilayer ceramic capacitor may be improved.

In addition, in the grain boundary 20, an atomic ratio X/Ti of inorganic elements (X) to titanium (Ti) may be 0.010 to 0.065, for example, 0.015 to 0.064. When the atomic ratio X/Ti of inorganic elements to titanium (Ti) is within the range, the reliability of the multilayer ceramic capacitor may be improved.

The inorganic element may further include at least one selected from the group consisting of dysprosium (Dy), magnesium (Mg), manganese (Mn), barium (Ba), aluminum (Al), vanadium (V), calcium (Ca), lithium (Li), copper (Cu), terbium (Tb), niobium (Nb), samarium (Sm), gadolinium (Gd), or a combination thereof, in addition to silicon (Si). For example, the inorganic element may further include dysprosium (Dy), magnesium (Mg), manganese (Mn), barium (Ba), aluminum (Al), and combinations thereof.

The grain boundary 20 may further include a secondary component comprising at least one selected from the group consisting of dysprosium (Dy), terbium (Tb), manganese (Mn), vanadium (V), barium (Ba), silicon (Si), aluminum (AI), calcium (Ca), and combinations thereof.

As an example, the secondary component may include dysprosium (Dy). When the secondary component includes dysprosium (Dy), in the grain boundary 20, an atomic ratio X/Dy of the inorganic elements (X) to dysprosium (Dy) may be 0.10 to 3.00, for example 0.30 to 2.60. When the atomic ratio of the inorganic elements to dysprosium (Dy) is within the range, the reliability of the multilayer ceramic capacitor may be improved.

The aforementioned X/Ni atomic ratio, X/Ti atomic ratio and X/Dy atomic ratio may be obtained by transmission electron microscope-energy dispersive spectroscopy (TEM-EDS) analysis. Here, since the TEM-EDS analysis is the same as the method for measuring the standard deviation of atom % of inorganic elements described above, the description thereof is omitted.

At least one of the plurality of dielectric grains 10 may have a core-shell structure including a core portion 11 and a shell portion 12 surrounding the core portion 11.

The core portion 11 may include a barium titanate-based primary component containing barium (Ba) and titanium (Ti).

The shell portion 12 may include a barium titanate-based primary component containing barium (Ba) and titanium (Ti), and inorganic elements including silicon (Si). When the shell portion includes inorganic elements such as silicon (Si), the reliability of the multilayer ceramic capacitor may be improved. The inorganic element included in the shell portion 12 may further include, in addition to silicon (Si), at least one selected from the group consisting of dysprosium (Dy), magnesium (Mg), manganese (Mn), barium (Ba), aluminum (Al), vanadium (V), calcium (Ca), lithium (Li), copper (Cu), terbium (Tb), niobium (Nb), samarium (Sm), gadolinium (Gd), and combinations thereof.

The shell portion 12 may further include a secondary component comprising at least one selected from the group consisting of dysprosium (Dy), terbium (Tb), manganese (Mn), vanadium (V), barium (Ba), silicon (Si), aluminum (Al), calcium (Ca), and combinations thereof.

According to some embodiments, in scanning electron microscope-energy dispersive spectroscopy (SEM-EDS) line analysis of the active area, the amplitude of the peak of silicon (Si) in the dielectric layer 111 may be 8.6 kcps to 25 kcps, for example, 8.6 kcps to 23 kcps. In the SEM-EDS line analysis, if the amplitude of the peak of silicon (Si) is within the range, the fluctuation of the peak intensity of silicon (Si) is large and compared to the Si content in the adjacent internal electrode layers 121 and 122, it means that the content of silicon (Si) is high in the dielectric layer 111. This may be a result of preparing and using dielectric powder coated with additive components such as inorganic elements on the surface of the barium titanate-based primary component. For reference, the Si content present in the internal electrode layer may be dispersed and derived from the Si component introduced in the form of an inorganic salt during firing to prepare the dielectric powder when forming the dielectric layer.

The amplitude of the silicon (Si) peak is a value expressed based on the minimum value of the silicon (Si) peak set to 0.

The SEM-EDS line analysis may be performed by the following method. A cross-sectional sample may be obtained to observe the active area where the dielectric layers 111 and the internal electrode layers 121 and 122 cross each other and the cover portion corresponding to any one of the first surface and the second surface in the active area in the thickness direction (T-axis direction), by putting and curing the multilayer ceramic capacitor 100 in an epoxy mixing solution, polishing a W- and T-axis directional surface (WT surface) of the capacitor body 110 to a depth of ½ in the L-axis direction, and fixing the WT surface and then maintaining the WT surface in a vacuum atmosphere chamber. Next, the active area and a part of the cover portion of the cross-sectional sample may be measured under a scanning electron microscope (SEM). The SEM uses, for example, a Verios G4 product from Thermofisher Scientific, the measurement conditions are 10 Kv and 0.2 nA, the analysis magnification may be 50 k times, and at least 1 layer, 3 layers, 5 layers, or 10 layers of dielectric layers 111 and internal electrode layers 121 and 122 may be measured to be exposed. Next, in the SEM image of the measured cross-sectional sample, in a line from the cover portion to some points in the active area, such as points passing through at least two layers, for example 2 to 10 layers of dielectric layers and the internal electrode layers, EDS analysis is performed on at least one, for example, 1 to 100, 2 to 50, and 3 to 30 points in the dielectric layer to obtain the amplitude for the peak of silicon (Si) in the dielectric layer.

The average thickness (average length in the T-axis direction) of the dielectric layer 111 may be 0.3 μm to 8.0 μm, for example, 0.5 μm to 7.8 μm. When the average thickness of the dielectric layer 111 is within the range, the reliability of the multilayer ceramic capacitor is excellent.

The average thickness of the dielectric layer 111 may be measured by scanning electron microscope (SEM) analysis by putting and curing the multilayer ceramic capacitor 100 in an epoxy mixing solution, polishing the multilayer ceramic capacitor 100, and then ion-milling the multilayer ceramic capacitor 100. The SEM uses, for example, a Verios G4 product from Thermofisher Scientific, the measurement conditions are 10 Kv and 0.2 nA, the analysis magnification may be 100 times, and at least 1 layer, 3 layers, 5 layers, or 10 layers of dielectric layers 111 may be measured to be exposed. In the SEM image, a center point in the longitudinal direction (L-axis direction) or width direction (W-axis direction) of the dielectric layer 111 is set as a reference point, and an arithmetic mean value of the thicknesses of the dielectric layers 111 may be obtained at 10 points spaced at predetermined intervals from the reference point. The intervals between 10 points may be adjusted according to the scale of the SEM image, and may be intervals of, for example, 1 μm to 100 μm, 1 μm to 50 μm, or 1 μm to 10 μm. At this time, all 10 points need to be located in the dielectric layer 111, and if all 10 points are not located within the dielectric layer 111, the position of the reference point may be changed or the intervals between the 10 points may be adjusted.

The first internal electrode 121 and the second internal electrode 122 are electrodes having different polarities and are alternately disposed to face each other along the T-axis direction with the dielectric layer 111 interposed therebetween, and one ends of the internal electrodes may be exposed through the third and fourth surfaces of the capacitor body 110, respectively.

The first internal electrode 121 and the second internal electrode 122 may be electrically insulated from each other by the dielectric layer 111 disposed therebetween.

The ends of the first internal electrode 121 and the second internal electrode 122 alternately exposed through the third and fourth surfaces of the capacitor body 110 may be connected with the first external electrode 131 and the second external electrode 132 to be electrically connected to each other.

The first internal electrode 121 and the second internal electrode 122 may include conductive metals, for example, metals such as Ni, Cu, Ag, Pd, Au, or alloys thereof, such as an Ag—Pd alloy.

In addition, the first internal electrode 121 and the second internal electrode 122 may also include dielectric particles including the same composition as the ceramic material included in the dielectric layer 111.

The first internal electrode 121 and the second internal electrode 122 may be formed using a conductive paste containing a conductive metal. A printing method of the conductive paste may be a screen-printing method or a gravure printing method.

The average thickness of the first internal electrode 121 and the second internal electrode 122 may be 0.1 μm to 2 μm. The average thickness of the first internal electrode 121 and the second internal electrode 122 may be measured by scanning electron microscope (SEM) analysis. Here, since the SEM analysis is the same as the method for measuring the average thickness of the dielectric layer 111 described above, the description thereof is omitted.

The capacitor body 110 may be formed by firing a laminate in which a plurality of dielectric layers 111 and internal electrode layers 121 and 122 are laminated.

The first external electrode 131 and the second external electrode 132 are provided with voltages of different polarities and are respectively connected to exposed portions of the first internal electrode 121 and the second internal electrode 122 to be electrically connected with each other.

According to the configuration described above, when a predetermined voltage is applied to the first external electrode 131 and the second external electrode 132, charges are accumulated between the first internal electrode 121 and the second internal electrode 122 facing each other. At this time, the capacitance of the multilayer ceramic capacitor 100 is proportional to the overlapped area of the first internal electrode 121 and the second internal electrode 122 that overlap each other along the T-axis direction in the active area.

The first external electrode 131 and the second external electrode 132 may include first and second connection portions that are disposed on the third and fourth surfaces of the capacitor body 110, respectively, to be connected with the first internal electrode 121 and the second internal electrode 122, and first and second band portions that are disposed at edges where the third and fourth surfaces, the first and second surfaces, or the fifth and sixth surfaces of the capacitor body 110 meet each other.

The first and second band portions may extend from the first and second connection portions to parts of the first and second surfaces or the fifth and sixth surfaces of the capacitor body 110, respectively. The first and second band portions may serve to improve the adhesion strength of the first external electrode 131 and the second external electrode 132.

The first external electrode 131 and the second external electrode 132 may each include a sintered metal layer in contact with the capacitor body 110, a conductive resin layer disposed to cover the sintered metal layer, and a plating layer disposed to cover the conductive resin layer.

The sintered metal layer may include a conductive metal and glass.

The conductive metal may include at least one selected from the group consisting of copper (Cu), nickel (Ni), silver (Ag), palladium (Pd), gold (Au), platinum (Pt), tin (Sn), tungsten (W), titanium (Ti), lead (Pb), an alloy thereof, and combinations thereof. For example, conductive metal may include the copper (Cu) or a copper (Cu) alloy. When the conductive metal contains copper, metals other than copper may be included in an amount of 5 parts by mole or less based on 100 parts by mole of copper.

The glass may include a composition with mixed oxides, for example, one or more selected from the group consisting of silicon oxide, boron oxide, aluminum oxide, transition metal oxide, alkali metal oxide, and alkaline earth metal oxide. The transition metal may be selected from the group consisting of zinc (Zn), titanium (Ti), copper (Cu), vanadium (V), manganese (Mn), iron (Fe), and nickel (Ni), the alkali metal may be selected from the group consisting of lithium (Li), sodium (Na), and potassium (K), and the alkaline earth metal may be one or more selected from the group consisting of magnesium (Mg), calcium (Ca), strontium (Sr), and barium (Ba).

Optionally, the conductive resin layer is formed on the sintered metal layer, and for example, may be formed to fully cover the sintered metal layer. Meanwhile, the first external electrode 131 and the second external electrode 132 may not include a sintered metal layer, and in this case, the conductive resin layer may be in direct contact with the capacitor body 110.

The conductive resin layer extends to the first and second surfaces or the fifth and sixth surfaces of the capacitor body 110, and the length of an area (that is, a band portion) where the conductive resin layer extends to the first and second surfaces or the fifth and sixth surfaces of the capacitor body 110 may be greater than the length of an area (that is, a band portion) where the sintered metal layer extends to the first and second surfaces or the fifth and sixth surfaces of the capacitor body 110. The conductive resin layer is formed on the sintered metal layer and may be formed to fully cover the sintered metal layer.

The conductive resin layer may include a resin and a conductive metal.

The resin included in the conductive resin layer is not particularly limited as long as the resin has adhesion and shock absorption properties and may be mixed with conductive metal powder to make a paste, and may include, for example, a phenolic resin, an acrylic resin, a silicone resin, an epoxy resin, or a polyimide resin.

The conductive metal included in the conductive resin layer may serve to be electrically connected with the first internal electrode 121 and the second internal electrode 122 or the sintered metal layer.

The conductive metal included in the conductive resin layer may have a spherical shape, a flake shape, or a combination thereof. That is, the conductive metal may be formed only in a flake shape or a spherical shape or may also be in a mixed form of the flake shape and the spherical shape.

Here, the spherical shape may also include a shape that is not a perfectly spherical shape, for example, a shape in which the length ratio of the major axis and the minor axis (major axis/minor axis) is 1.45 or less. The flake-shaped powder refers to powder with a flat and elongated shape, and is not particularly limited, but for example, the length ratio of the major axis to the minor axis (major axis/minor axis) may be 1.95 or more.

The first external electrode 131 and the second external electrode 132 may further include a plating layer disposed outside the conductive resin layer.

The plating layer may include at least one selected from the group consisting of nickel (Ni), copper (Cu), tin (Sn), palladium (Pd), platinum (Pt), gold (Au), silver (Ag), tungsten (W), titanium (Ti), lead (Pb), and an alloy thereof. For example, the plating layer may be a nickel (Ni) plating layer or a tin (Sn) plating layer and may be a form in which a nickel (Ni) plating layer and a tin (Sn) plating layer are sequentially laminated, and also be a form in which a tin (Sn) plating layer, a nickel (Ni) plating layer, and a tin (Sn) plating layer are sequentially laminated. In addition, the plating layer may also include a plurality of nickel (Ni) plating layers and/or a plurality of tin (Sn) plating layers.

The plating layer may improve mountability to the substrate, structural reliability, durability to the outside, heat resistance, and equivalent series resistance (ESR) of the multilayer capacitor 100.

Hereinafter, a method of preparing the multilayer ceramic capacitor 100 according to an embodiment will be described.

The multilayer ceramic capacitor 100 according to an embodiment may be fabricated by preparing dielectric powder in which the surface of a barium titanate-based primary component containing barium (Ba) and titanium (Ti) is coated with inorganic elements containing silicon (Si); preparing a dielectric green sheet using a dielectric slurry including the dielectric powder and forming a conductive paste layer on the surface of the dielectric green sheet; preparing a dielectric green sheet laminate by laminating the dielectric green sheets on which the conductive paste layer is formed; preparing a capacitor body including a dielectric layer and an internal electrode layer by firing the dielectric green sheet laminate; and forming an external electrode on one surface of the capacitor body.

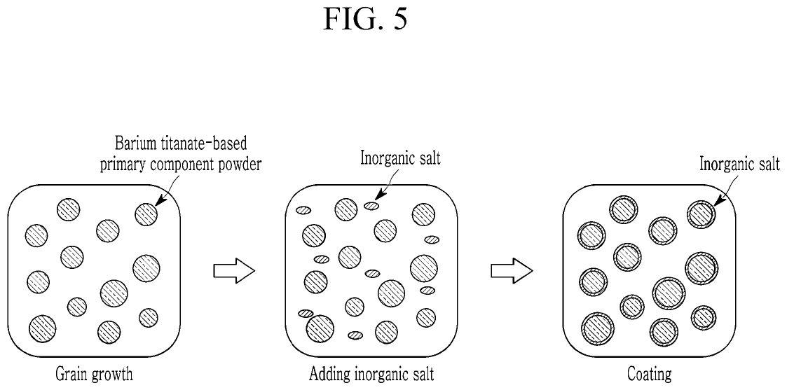

First, steps for preparing the dielectric powder will be described with reference to FIG. 5.

FIG. 5 is a schematic diagram illustrating a method of preparing dielectric powder according to an embodiment.

Referring to FIG. 5, the dielectric powder in which the surface of a barium titanate-based primary component is coated with inorganic elements including silicon (Si) may be prepared by performing hydrothermal synthesis and grain growth of the barium titanate-based primary component powder; adding an inorganic salt containing silicon (Si) after the grain growth is completed; and performing heat treatment after adding the inorganic salt.

The hydrothermal synthesis of the barium titanate-based primary component powder may be performed by mixing titanium (Ti) precursors such as oxides, hydroxides, chlorides, and nitrates of titanium (Ti) and barium (Ba) precursors such as oxides, hydroxides, chlorides, and nitrates of barium (Ba) with an aqueous solvent and then reacting the mixture under high temperature and high pressure.

According to some embodiments, during the process of synthesizing barium titanate-based primary component powder in the aqueous system, the inorganic salt is added alone after the grain growth is completed, so that there is no need to process additional additives and the process time may be shortened. In addition, as the heat treatment is performed under high temperature and high pressure, a barium (Ba)-inorganic element composite phase is formed, and the inorganic elements may be uniformly coated on the surface of the barium titanate-based primary component.

The titanium (Ti) precursor and the barium (Ba) precursor may be mixed at a molar ratio of 1:0.5 to 1:1.5.

The high temperature and high pressure may be performed at a pressure of 0.5 MPa to 10 MPa and a temperature of 150° C. to 300° C.

After the grain growth of the barium titanate-based primary component powder is completed through hydrothermal synthesis, the inorganic salt containing silicon (Si) may be added.

The inorganic salt may further include, in addition to silicon (Si), at least one selected from the group consisting of dysprosium (Dy), magnesium (Mg), manganese (Mn), barium (Ba), aluminum (Al), vanadium (V), calcium (Ca), lithium (Li), copper (Cu), terbium (Tb), niobium (Nb), samarium (Sm), gadolinium (Gd), and combinations thereof. For example, the inorganic salt may further include dysprosium (Dy), magnesium (Mg), manganese (Mn), barium (Ba), aluminum (Al), or a combination thereof.

The inorganic salt may include an alkoxide-based compound containing inorganic elements such as silicon (Si). For example, the inorganic salt may include tetraethyl orthosilicate (TEOS), etc. The alkoxide-based compound may be stably hydrolyzed.

After the grain growth is completed, an inorganic salt, specifically an alkoxide-based compound containing inorganic elements, is added to the aqueous solution in which the barium titanate-based primary component powder is dispersed and heat treated, and thus a coating layer may be formed on the surface of the barium titanate-based primary component powder through the dissolution and re-precipitation process of the inorganic elements that are additive components.

Specifically, when the inorganic salt is added to the aqueous solution in which the barium titanate-based primary component powder is dispersed, by polymerization and neutralization reactions after the hydrolysis reaction of the inorganic salt, specifically the alkoxide-based compound containing inorganic elements, reactants of silicon (Si) oxide and barium (Ba) and titanium (Ti) ions may precipitate on the surface of the barium titanate-based primary component powder to form a coating layer.

The formed coating layer may serve as a dispersion path for secondary components such as dysprosium (Dy), etc., thereby improving the dispersion characteristics of the additives and helping in the formation of a shell in which the distribution of the additives is uniform.

The inorganic salt may be added in an amount of 0.1 parts by mole to 5.0 parts by mole, for example, 0.4 parts by mole to 3.3 parts by mole, based on 100 parts by mole of the barium titanate-based primary component powder. When the inorganic salt is added in the content range, the inorganic elements may be easily coated on the surface of the barium titanate-based primary component powder.

After the inorganic salt is added, heat treatment may be performed at a temperature or less for the grain growth of the barium titanate-based primary component powder. As an example, the heat treatment may be performed at a temperature of 100° C. to 300° C., for example, 150° C. to 250° C. When the heat treatment is performed in the temperature range, polymerization and neutralization reactions occur smoothly after the hydrolysis reaction, so that the inorganic elements may be easily coated on the surface of the barium titanate-based primary component powder.

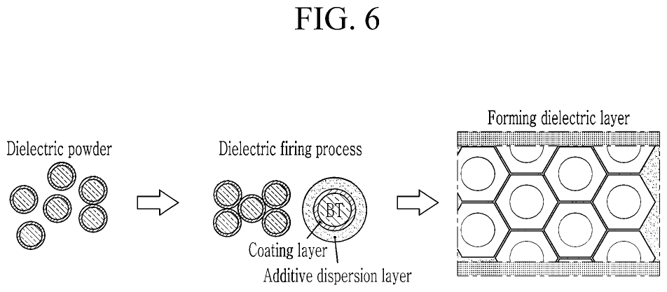

FIG. 6 is a schematic diagram illustrating a method of preparing a dielectric layer according to an embodiment.

Referring to FIG. 6, a dielectric layer may be formed from a dielectric slurry including the prepared dielectric powder through a dielectric firing process. The formed dielectric layer includes a dielectric grain having of a core-shell structure and a grain boundary. By using the dielectric powder prepared according to an embodiment, that is, the dielectric powder in which the surface of the barium titanate-based primary component is coated with inorganic elements containing silicon (Si), damage to the core portion may be minimized and the concentration of the inorganic elements in the grain boundary may be increased. Accordingly, a thin multilayer ceramic capacitor with excellent reliability may be prepared.

The dielectric slurry may further include secondary component powder including at least one selected from the group consisting of a dysprosium (Dy)-containing compound, a terbium (Tb)-containing compound, a manganese (Mn)-containing compound, a vanadium (V)-containing compound, a barium (Ba)-containing compound, a silicon (Si)-containing compound, an aluminum (Al)-containing compound, a calcium (Ca)-containing compound, and combinations thereof.

The secondary component powder may be an oxide, a nitride, or a salt compound, or may be used in the form of a sol dispersed in an organic solvent.

The secondary component powder may be included in an amount of 0.01 parts by mole to 5 parts by mole, for example, 0.1 to 3 parts by mole, based on 100 parts by mole of the barium titanate-based primary component powder. When the secondary component powder is contained in the content range, the thin multilayer ceramic capacitor with excellent reliability may be prepared.

The dielectric slurry may be prepared by additionally mixing solvents and additives such as a dispersant, a binder, a plasticizer, a lubricant, and an antistatic agent.

The dispersant may include, for example, a phosphoric acid ester-based dispersant, a polycarboxylic acid-based dispersant, or a combination thereof. The dispersant may be mixed at 0.1 parts by weight to 5 parts by weight, for example, 0.3 parts by weight to 3 parts by weight, based on 100 parts by weight of the barium titanate-based primary component powder. When the dispersant is mixed in the content range, the dispersibility of the dielectric slurry is excellent, and the amount of impurities contained in the prepared dielectric layer may be reduced.

The binder may include, for example, an acrylic resin, a polyvinyl butyl resin, a polyvinyl acetal resin, an ethylcellulose resin, or the like. The binder may be added in an amount of 0.1 parts by weight to 50 parts by weight, for example, 3 parts by weight to 30 parts by weight, based on 100 parts by weight of the barium titanate-based primary component powder. When the binder is mixed in the content range, the dispersibility of the dielectric slurry is excellent, and the amount of impurities contained in the prepared dielectric layer may be reduced.

The plasticizer may include, for example, phthalic acid-based compounds such as dioctyl phthalate, benzylbutyl phthalate, dibutyl phthalate, dihexyl phthalate, di(2-ethylhexyl) phthalate, and di(2-ethylbutyl) phthalate; adipic acid-based compounds such as dihexyl adipate and di(2-ethylhexyl) adipate; glycol-based compounds such as ethylene glycol, diethylene glycol, and triethylene glycol; glycol ester compounds such as triethylene glycol dibutyrate, triethylene glycol di(2-ethylbutyrate), and triethylene glycol di(2-ethylhexanoate), etc. The plasticizer may be added in an amount of 0.1 parts by weight to 20 parts by weight, for example, 1 part by weight to 10 parts by weight, based on 100 parts by weight of the barium titanate-based primary component powder. When the plasticizer is mixed in the content range, the dispersibility of the dielectric slurry is excellent, and the amount of impurities contained in the prepared dielectric layer may be reduced.

The solvent may be aqueous solvents such as water; alcohol-based solvents such as ethanol, methanol, benzyl alcohol, and methoxyethanol; glycol-based solvents such as ethylene glycol and diethylene glycol; ketone-based solvents such as acetone, methyl ethyl ketone, methyl isobutyl ketone, and cyclohexanone; ester solvents such as butyl acetate, ethyl acetate, carbitol acetate, and butyl carbitol acetate; ether-based solvents such as methyl cellosolve, ethyl cellosolve, butyl ether, and tetrahydrofuran; aromatic solvents such as benzene, toluene, and xylene, etc. For example, the solvent may include an alcohol-based solvent or an aromatic-based solvent, considering the solubility and dispersibility of various additives included in the dielectric slurry. The solvent may be mixed in an amount of 50 parts by weight to 1000 parts by weight, for example, 100 parts by weight to 500 parts by weight, based on 100 parts by weight of the barium titanate-based primary component powder. When the solvent is mixed in the content range, the dielectric slurry components may be sufficiently mixed, and thereafter, the removal of the solvent is easy.

A wet ball mill or a stirring mill may be used to mix the dielectric slurry containing the dielectric powder in which the surface of the barium titanate-based primary component is coated with inorganic elements. When using zirconia balls in the wet ball mill, a plurality of zirconia balls with a diameter of 0.1 mm to 10 mm may be used for wet mixing for 8 hours to 48 hours, or 10 hours to 24 hours.

The prepared dielectric slurry is formed into a dielectric layer after firing.

The method of forming the prepared dielectric slurry in a sheet shape may use tape forming methods such as a doctor blade method and a calendar roll method, for example, a head discharge type on-roll forming coater, and then a dielectric green sheet may be obtained by drying a molded body.

To form the conductive paste layer that becomes the internal electrode layer after firing, a conductive paste may be prepared by mixing a conductive powder including a conductive metal or an alloy thereof, a binder, and a solvent. In addition, barium titanate powder may be mixed together as a co-material if necessary. The co-material may act to suppress sintering of the conductive powder during the firing process. A conductive paste layer is formed by applying the conductive paste onto the surface of the dielectric green sheet in a predetermined pattern using various printing methods such as screen printing or a transfer method.

The conductive powder may include nickel (Ni) or a nickel (Ni) alloy.

Next, a dielectric green sheet laminate is prepared by laminating dielectric green sheets formed with internal electrode patterns in multiple layers and then pressing the dielectric green sheets in a laminating direction. At this time, the dielectric green sheets and the internal electrode patterns may be laminated so that the dielectric green sheets are located on the upper and lower surfaces of the dielectric green sheet laminate in the laminating direction.

The cutting of the prepared dielectric green sheet laminate to a predetermined size by dicing or the like may optionally be performed.

In addition, the dielectric green sheet laminate may be solidified and dried to remove plasticizers, etc., if necessary, and after solidifying and drying, the dielectric green sheet may be barrel-polished using a horizontal centrifugal barrel machine, etc. In the barrel polishing, the dielectric green sheet laminate is added into a barrel container together with media and a polishing liquid, and unnecessary parts such as burrs generated during cutting may be polished by applying rotational motion or vibration to the barrel container. In addition, after the barrel polishing, the dielectric green sheet laminate may be washed with a cleaning solution such as water and dried.

Subsequently, the dielectric green sheet laminate may be debindered and fired to prepare a capacitor body.

The debindering conditions may be appropriately adjusted depending on the components of the dielectric layer or the components of the internal electrode layer. For example, the heating rate during debindering may be 5° C./hour to 300° C./hour, the support temperature may be 180° C. to 400° C., and the temperature maintenance time may be 0.5 hour to 24 hours. The atmosphere during debindering may be an air or reducing atmosphere.

The firing conditions may be appropriately adjusted depending on the primary component composition of the dielectric layer or the primary component composition of the internal electrode. For example, the firing may be performed at a temperature of 1100° C. to 1400° C., for example, 1200° C. to 1350° C. The firing may also be performed for 0.5 hours to 8 hours, for example, 1 hour to 3 hours. In addition, the firing may be performed in a reducing atmosphere, for example, a humidified atmosphere of mixed gas of nitrogen and hydrogen. When the internal electrode includes nickel (Ni) or a nickel (Ni) alloy, the oxygen partial pressure in the firing atmosphere may be 1.0×10⁻¹⁴ MPa to 1.0×10⁻¹⁰ MPa.

After firing, annealing may be performed as needed. The annealing is a treatment to reoxidize the dielectric layer, and the annealing may be performed when the dielectric layer is fired in a reducing atmosphere. The annealing conditions may also be appropriately adjusted depending on the components of the dielectric layer. For example, the temperature during annealing may be 950° C. to 1150° C., the time during annealing may be 0 to 20 hours, and the heating rate may be 50° C./hour to 500° C./hour. The annealing atmosphere may be a humidified nitrogen gas (N₂) atmosphere, and the oxygen partial pressure may be 1.0×10⁻⁹ MPa to 1.0×10⁻⁵ MPa.

In the debindering, firing, or annealing, for example, a wetter and the like may be used to humidify nitrogen gas or mixed gas, and in this case, the water temperature may be 5° C. to 75° C. The debindering, firing, and annealing may be performed continuously or independently.

Optionally, surface treatment such as sand blasting, laser irradiation, barrel polishing, etc. may be performed on the third and fourth surfaces of the prepared capacitor body 110. By performing this surface treatment, the ends of the first internal electrode and the second internal electrode may be exposed to the outermost surfaces of the third and fourth surfaces, and accordingly, the electrical connections between the first external electrode and the second external electrode, and between the first internal electrode and the second internal electrode becomes good, and the alloy portion may be easily formed. Next, an external electrode is formed on one surface of the prepared capacitor body 110.

As an example, a sintered metal layer forming paste may be applied to the external electrode and then sintered to form a sintered metal layer.

The sintered metal layer forming paste may include a conductive metal and glass.

Since the description of the conductive metal and the glass is the same as described above, the repeated description will be omitted. In addition, the sintered metal layer forming paste may optionally include a binder, a solvent, a dispersant, a plasticizer, an oxide powder, etc. The binder may be, for example, ethylcellulose, acrylic, butyral, etc., and the solvent may be, for example, an organic solvent or aqueous solvent such as terpineol, butylcarbitol, alcohol, methylethylketone, acetone, toluene, etc.

The method of applying the sintered metal layer forming paste on the outer surface of the capacitor body 110 may use various printing methods such as a dip method, screen printing, etc., application method using a dispenser, etc., and spraying method using spray. The sintered metal layer forming paste is applied to at least the third and fourth surfaces of the capacitor body 110 and may be optionally applied to some of the first, second, fifth or sixth surfaces on which the band portions of the first and second external electrodes are formed.

Thereafter, the capacitor body 110 onto which the sintered metal layer forming paste is applied is dried and sintered at a temperature of 700° C. to 1000° C. for 0.1 to 3 hours to form a sintered metal layer.

Optionally, a conductive resin layer forming paste may be applied to the outer surface of the obtained capacitor body 110 and then cured to form a conductive resin layer.

The conductive resin layer forming paste may include a resin and selectively a conductive metal or a non-conductive filler. Since the description of the conductive metal and the resin is the same as described above, the repeated description will be omitted. In addition, the conductive resin layer forming paste may optionally include a binder, a solvent, a dispersant, a plasticizer, an oxide powder, etc. The binder may be, for example, ethylcellulose, acrylic, butyral, etc., and the solvent may be an organic solvent or aqueous solvent such as terpineol, butylcarbitol, alcohol, methylethylketone, acetone, toluene, etc.

For example, method of forming the conductive resin layer may include dipping the capacitor body 110 in the conductive resin layer forming paste and then curing the conductive resin layer forming paste to form the conductive resin, or printing the conductive resin layer forming paste on the surface of the capacitor body 110 by screen printing, gravure printing, etc., or applying and then curing the conductive resin layer forming paste on the surface of the capacitor body 110.

Next, a plating layer is formed on the outside of the conductive resin layer.

For example, the plating layer may be formed by a plating method or may also be formed by sputtering or electrolytic plating (electric deposition).

The above-described embodiments will be described in more detail through Examples below. However, the following Examples are only for illustrative purposes and do not limit the scope of the present disclosure.

### (Preparation of Multilayer Ceramic Capacitor)

### Examples 1 to 3

Titanium hydroxide and barium hydroxide were mixed at a molar ratio of 1:1.1, and subjected to a hydrothermal reaction at a pressure of 4 MPa and a temperature of 250° C. to grain-grow barium titanate (BaTiO₃) powder. Tetraethyl orthosilicate (TEOS) was added to an aqueous solution in which the barium titanate powder in which grain growth was completed was dispersed at 0.8 parts by mole based on 100 parts by mole of the barium titanate powder. Next, heat treatment was performed at a temperature of 200° C. for 2 hours to prepare dielectric powder in which the surface of a barium titanate-based primary component was coated with Si.

A dielectric slurry was prepared by mixing the prepared dielectric powder and dysprosium oxide (Dy₂O₃) at 0.8 parts by mole with respect to 100 parts by mole of the barium titanate powder.

The mixing was performed by using zirconia balls (ZrO₂ balls) as a dispersion medium, adding ethanol/toluene and a polyvinyl butyral (PVB) resin as a wetting dispersant and a binder and then mechanical milling.

A dielectric green sheet was prepared from the prepared dielectric slurry using a head ejection type on-roll forming coater.

A dielectric green sheet laminate was prepared by printing a conductive paste layer containing nickel (Ni) on the surface of the dielectric green sheet, and laminating and compressing the dielectric green sheet (width×length×height=3.2 mm×2.5 mm×2.5 mm) formed with the conductive paste layer.

The dielectric green sheet laminate was fired at a temperature of 1300° C. or lower and a hydrogen concentration of 1.0% H₂ or lower through a plasticizing process in a nitrogen atmosphere at 400° C. or lower. For reference, Examples 1 to 3 were prepared by firing at a firing temperature of 1150° C. to 1170° C., specifically at 1150° C., 1160° C., and 1170° C., respectively.

Next, a multilayer ceramic capacitor was prepared through processes such as external electrodes and plating.

### Comparative Examples 1 to 4

Titanium hydroxide and barium hydroxide were mixed at a molar ratio of 1:1.1, subjected to a hydrothermal reaction at a pressure of 4 MPa and a temperature of 250° C., and then dried to prepare barium titanate (BaTiO₃) powder.

A dielectric slurry was prepared by mixing the prepared barium titanate powder and silicon dioxide (SiO₂) and dysprosium oxide (Dy₂O₃) as secondary element powder. At this time, silicon dioxide (SiO₂) and dysprosium oxide (Dy₂O₃) were mixed at 0.8 parts by mole and 0.8 parts by mole based on 100 parts by mole of barium titanate powder, respectively. The mixing was performed by using zirconia balls (ZrO₂ balls) as a dispersion medium, adding ethanol/toluene and a polyvinyl butyral (PVB) resin as a wetting dispersant and a binder and then mechanical milling.

A multilayer ceramic capacitor was fabricated using the prepared dielectric slurry in the same manner as in Example 1. At this time, Comparative Examples 1 to 4 were prepared by firing at a firing temperature of 1150° C. to 1180° C., specifically at 1150° C., 1160° C., 1170° C. and 1180° C., respectively.

### Evaluation 1: TEM-EDS Analysis

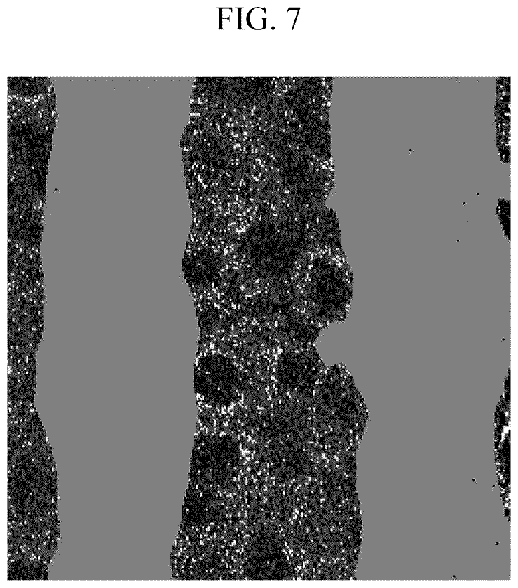

Transmission electron microscopy-energy dispersive spectroscopy (TEM-EDS) analysis was performed on the multilayer ceramic capacitors fabricated in Examples 1 to 3 and Comparative Examples 1 to 4, and the results were illustrated in FIG. 7 and Table 1.

The TEM-EDS analysis was performed by the following method. A cross-sectional sample was obtained to observe an active area where dielectric layers and internal electrode layers crossed each other, by putting and curing the multilayer ceramic capacitors prepared in Examples 1 to 3 and Comparative Examples 1 to 4 in an epoxy mixing solution, and then polishing a W- and T-axis directional surface (WT surface) of the capacitor body 110 to a depth of ½ in an L-axis direction, and fixing the WT surface and then maintaining the WT surface in a vacuum atmosphere chamber. In the active area of the cross-sectional sample, three dielectric layers and two internal electrode layers in the center were measured using TEM to be exposed. The TEM was measured using a Xe-FIB (focused ion beam) under the conditions of an acceleration voltage of 200 kV and an analysis magnification of 79 k. The measured image of Example 1 was shown in FIG. 7.

In the TEM image of the measured cross-sectional sample, EDS analysis was performed on seven random points at the grain boundary in the dielectric layer, and a standard deviation of Si atom %, a Si/Ti atomic ratio, a Si/Ni atomic ratio and a Si/Dy atomic ratio were calculated and shown in Table 1 below, respectively. Here, the standard deviation of Si atom % represents the standard deviation of Si atom % with respect to the total amount of components of the grain boundary, and the standard deviation is the square root of the average of the squares of the deviations.

FIG. 7 is a TEM analysis image of an active area of a multilayer ceramic capacitor according to Example 1.

TABLE 1

| | Standard | Si/Ti | Si/Ni | Si/Dy |
|---|---|---|---|---|
| | deviation of | atomic | atomic | atomic |
| | Si atom % | ratio | ratio | ratio |
| Example 1 | 0.21 | 0.019 | 1.727 | 0.5 |
| Example 2 | 0.26 | 0.056 | 1.052 | 2.193 |
| Example 3 | 0.67 | 0.0627 | 1.015 | 2.35 |
| Comparative | 0.98 | 0.066 | 2.222 | 3.216 |
| Example 1 | | | | |
| Comparative | 1.02 | 0.0787 | 2.225 | 3.095 |
| Example 2 | | | | |
| Comparative | 0.83 | 0.0934 | 2.341 | 3.174 |
| Example 3 | | | | |
| Comparative | 1.265 | 0.137 | 4.573 | 3.645 |
| Example 4 | | | | |

Through Table 1, in Examples 1 to 3 using dielectric powder with silicon (Si) coated on the surface of barium titanate according to one embodiment, compared to Comparative Examples 1 to 4, it can be seen that the standard deviation of Si atom % has values in the range of 0.20 to 0.80. From these results, it can be seen that the dielectric layer of the multilayer ceramic capacitor according to an embodiment has inorganic elements uniformly distributed on the surface of barium titanate within the grain boundary.

### Evaluation 2: SEM-EDS Line Analysis

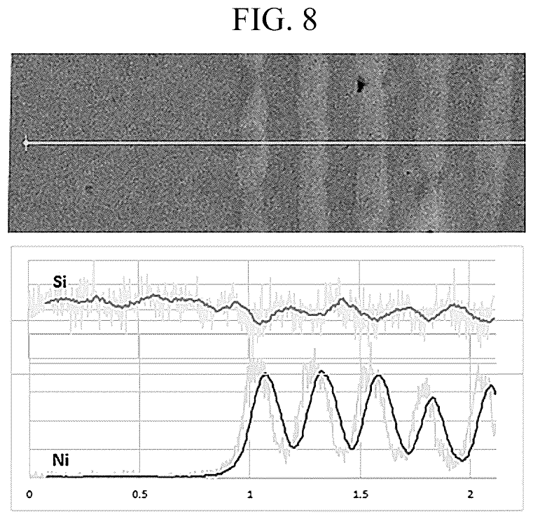

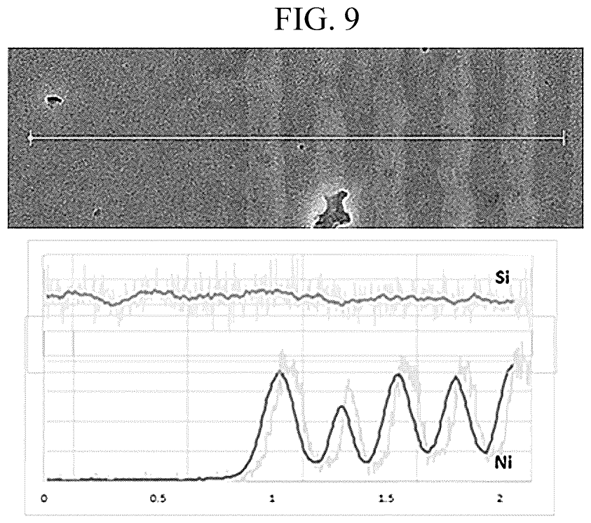

Scanning electron microscopy-energy dispersive spectroscopy (SEM-EDS) line analysis was performed on the multilayer ceramic capacitors fabricated in Example 1 and Comparative Example 1, and the results were shown in FIGS. 8 and 9 and Table 2.

The SEM-EDS line analysis was performed by the following method. A cross-sectional sample was obtained to observe an active area where dielectric layers 111 and internal electrode layers 121 and 122 crossed each other and a cover portion corresponding to a first surface of the active area in the thickness direction (T-axis direction), by putting and curing the multilayer ceramic capacitor 100 in an epoxy mixing solution, and then polishing a W- and T-axis directional surface (WT surface) of the capacitor body 110 to a depth of ½ in an L-axis direction, and fixing the WT surface and then maintaining the WT surface in a vacuum atmosphere chamber. Next, five dielectric layers and internal electrode layers in the active area from the cover portion of the cross-sectional sample were measured by scanning electron microscope (SEM) to be exposed. The SEM used, for example, a Verios G4 product from thermofisher scientific Co., Ltd., and the measurement conditions were 10 kV and 0.2 nA, and the analysis magnification was 50 k times. Next, in the SEM image of the measured cross-sectional sample, in a line from the cover portion to the five dielectric layers and the internal electrode layers of the active area, EDS analysis was performed on seven points in the dielectric layer to calculate the amplitude for the peak of silicon (Si) in the dielectric layer. In Table 2 below, the unit of amplitude was kcps, and the minimum value of the silicon (Si) peak was designated as 0, which was indicated as a reference.

FIG. 8 is a SEM-EDS line analysis image of a cover portion and an active area of the multilayer ceramic capacitor according to Example 1 and FIG. 9 is a SEM-EDS line analysis image of a cover portion and an active area of a multilayer ceramic capacitor according to Comparative Example 1.

TABLE 2

| | Example 1 | Comparative Example 1 |
|---|---|---|
| #1 | 21 | 8.5 |
| #2 | 21.5 | 3.5 |
| #3 | 8.6 | 5 |
| #4 | 11.5 | 3 |
| #5 | 14.5 | 2 |
| #6 | 16 | 4 |
| #7 | 16.5 | 5.5 |

As shown in FIGS. 8 and 9 and Table 2, in Example 1 using dielectric powder coated with silicon (Si) on the surface of barium titanate according to an embodiment, compared to Comparative Example 1, it can be seen that the amplitude of the peak of silicon (Si) in the dielectric layer satisfies the range of 8.6 kcps to 25 kcps. This means that the peak intensity of silicon (Si) fluctuates greatly, and as a result, it can be seen that the content of silicon (Si) in the dielectric layer is greater than the Si content in the adjacent internal electrode layer.

### Evaluation 3: Reliability

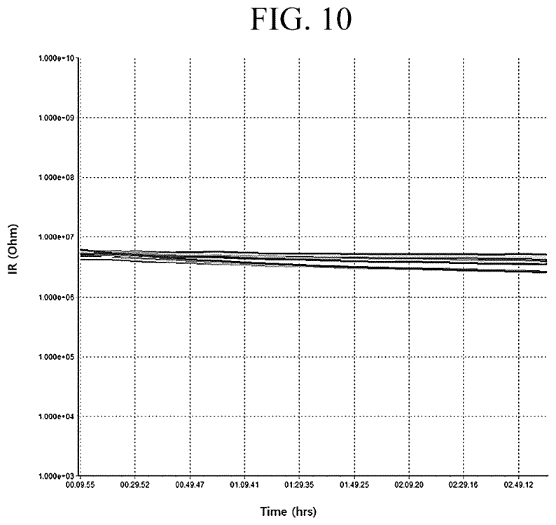

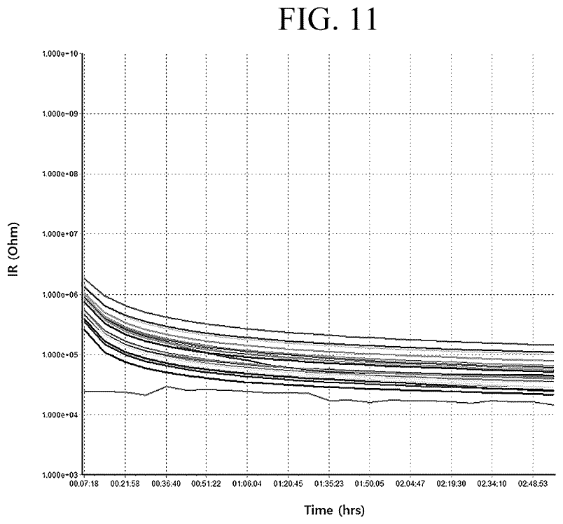

High-temperature stress reliability (HALT) was measured for the multilayer ceramic capacitors fabricated in Example 1 and Comparative Example 1, and the results were shown in FIGS. 10 and 11.

Specifically, each of the multilayer ceramic capacitors fabricated in Example 1 and Comparative Example 1 was prepared and mounted on a measurement substrate, and high-temperature stress reliability (HALT) was measured under conditions of 105° C., 12 hours, and 2Vr using ESPEC (PV-222, HALT) equipment.

FIG. 10 is a graph showing high-temperature stress reliability of the multilayer ceramic capacitor according to Example 1 and FIG. 11 is a graph showing high-temperature stress reliability of the multilayer ceramic capacitor according to Comparative Example 1.

Referring to FIGS. 10 and 11, in Example 1, where the standard deviation of the atom % of the inorganic element of Si had a value in the range of 0.20 to 0.80, compared to Comparative Example 1, it can be seen that the distribution characteristic of insulation resistance (IR) was excellent and thus the high-temperature stress reliability was excellent.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

100: Multilayer ceramic capacitor
110: Capacitor body
111: Dielectric layer
121: First internal electrode
122: Second internal electrode
131: First external electrode
132: Second external electrode
10: Dielectric grain
11: Core portion
12: Shell portion
20: Grain boundary

What is claimed is:

1. A multilayer ceramic capacitor comprising:
a capacitor body including dielectric layers and internal electrode layers; and
an external electrode disposed outside the capacitor body,
wherein the dielectric layer includes a plurality of dielectric grains and grain boundaries located between the dielectric grains adjacent to each other,
the grain boundary includes a barium titanate-based primary component containing barium (Ba) and titanium (Ti), and an inorganic element including silicon (Si), and
a standard deviation of atom % of the inorganic element to a total amount of components of the grain boundary is 0.20 to 0.80, and the standard deviation is obtained as a square root of an average of the squares of the deviations.

2. The multilayer ceramic capacitor of claim 1, wherein:
the grain boundary includes a barium (Ba)-inorganic element composite phase.

3. The multilayer ceramic capacitor of claim 1, wherein:
the grain boundary further includes nickel (Ni), and
in the grain boundary, an atomic ratio of the inorganic element to nickel (Ni) is 1.00 to 2.10.

4. The multilayer ceramic capacitor of claim 1, wherein:
in the grain boundary, an atomic ratio of the inorganic element to titanium (Ti) is 0.010 to 0.065.

5. The multilayer ceramic capacitor of claim 1, wherein:
the inorganic element further includes at least one selected from the group consisting of dysprosium (Dy), magnesium (Mg), manganese (Mn), barium (Ba), aluminum (Al), vanadium (V), calcium (Ca), lithium (Li), copper (Cu), terbium (Tb), niobium (Nb), samarium (Sm), gadolinium (Gd), and combinations thereof.

6. The multilayer ceramic capacitor of claim 1, wherein:
the grain boundary further includes a secondary component selected from the group consisting of dysprosium (Dy), terbium (Tb), manganese (Mn), vanadium (V), barium (Ba), silicon (Si), aluminum (Al), calcium (Ca), and combinations thereof.

7. The multilayer ceramic capacitor of claim 6, wherein:
the secondary component includes the dysprosium (Dy), and
in the grain boundary, an atomic ratio of the inorganic element to dysprosium (Dy) of the secondary component is 0.10 to 3.00.

8. The multilayer ceramic capacitor of claim 1, wherein:
at least one of the plurality of dielectric grains comprises a core portion and a shell portion surrounding the core portion.

9. The multilayer ceramic capacitor of claim 8, wherein:
the shell portion includes a barium titanate-based primary component containing barium (Ba) and titanium (Ti), and an inorganic element including silicon (Si).

10. The multilayer ceramic capacitor of claim 8, wherein:
the inorganic element of the shell portion further includes at least one selected from the group consisting of dysprosium (Dy), magnesium (Mg), manganese (Mn), barium (Ba), aluminum (Al), vanadium (V), calcium (Ca), lithium (Li), copper (Cu), terbium (Tb), niobium (Nb), samarium (Sm), gadolinium (Gd), and combinations thereof.

11. The multilayer ceramic capacitor of claim 8, wherein:
the shell portion further includes a secondary component selected from the group consisting of dysprosium (Dy), terbium (Tb), manganese (Mn), vanadium (V), barium (Ba), silicon (Si), aluminum (Al), calcium (Ca), and combinations thereof.

12. The multilayer ceramic capacitor of claim 1, wherein:
the capacitor body has an active area in which the dielectric layers and the internal electrode layers are alternately disposed, and
an amplitude of a peak of silicon (Si) in the dielectric layer is 8.6 kcps to 25 kcps with Scanning Electron Microscope-Energy Dispersive Spectroscopy (SEM-EDS) line analysis for the active area.

13. A method of fabricating a multilayer ceramic capacitor comprising:
preparing dielectric powder in which a surface of a barium titanate-based primary component containing barium (Ba) and titanium (Ti) is coated with inorganic element including silicon (Si);
preparing a dielectric green sheet using a dielectric slurry including the dielectric powder and forming a conductive paste layer on a surface of the dielectric green sheet;
laminating the dielectric green sheets on which the conductive paste layer is formed to prepare a dielectric green sheet laminate;
firing the dielectric green sheet laminate to prepare a capacitor body including a dielectric layer and an internal electrode layer; and
forming an external electrode on one surface of the capacitor body,
wherein the dielectric layer includes a plurality of dielectric grains and grain boundaries located between the adjacent dielectric grains,
the grain boundary includes a barium titanate-based primary component containing barium (Ba) and titanium (Ti), and inorganic element including silicon (Si), and
a standard deviation of atom % of the inorganic element to a total amount of components of the grain boundary is 0.20 to 0.80, and the standard deviation is obtained as a square root of an average of the squares of the deviations.

14. The method of fabricating the multilayer ceramic capacitor of claim 13, wherein:
the preparing of the dielectric powder comprises
performing hydrothermal synthesis and grain growth of the barium titanate-based primary component powder;
adding an inorganic salt containing silicon (Si) after the grain growth is completed; and
performing heat treatment after adding the inorganic salt.

15. The method of fabricating the multilayer ceramic capacitor of claim 14, wherein:
the inorganic salt further includes at least one selected from the group consisting of dysprosium (Dy), magnesium (Mg), manganese (Mn), barium (Ba), aluminum (Al), vanadium (V), calcium (Ca), lithium (Li), copper (Cu), terbium (Tb), niobium (Nb), samarium (Sm), gadolinium (Gd), and combinations thereof.

16. The method of fabricating the multilayer ceramic capacitor of claim 14, wherein:
the inorganic salt includes an alkoxide-based compound.

17. The method of fabricating the multilayer ceramic capacitor of claim 14, wherein:
the inorganic salt is added in an amount of 0.1 parts by mole to 5.0 parts by mole based on 100 parts by mole of the barium titanate-based primary component powder.

18. The method of fabricating the multilayer ceramic capacitor of claim 14, wherein:
the heat treatment is performed at a temperature of 100° C. to 300° C.

19. The method of fabricating the multilayer ceramic capacitor of claim 13, wherein:
the dielectric slurry further includes secondary component powder selected from the group consisting of a dysprosium (Dy)-containing compound, a terbium (Tb)-containing compound, a manganese (Mn)-containing compound, a vanadium (V)-containing compound, a barium (Ba)-containing compound, a silicon (Si)-containing compound, an aluminum (Al)-containing compound, a calcium (Ca)-containing compound, and combinations thereof.

20. The method of fabricating the multilayer ceramic capacitor of claim 19, wherein:
the secondary component powder is included in an amount of 0.01 parts by mole to 5 parts by mole based on 100 parts by mole of the barium titanate-based primary component powder.
